(19) United States
(12) Patent Application Publication
(10) Pub. No.: US 2011/0058396 A1
(43) Pub. Date: Mar. 10, 2011

(54) FLYBACK-TYPE INVERTER CIRCUIT FOR NETWORK SUPPLY OR FOR NETWORK-INDEPENDENT OPERATION

(75) Inventor: Hans Oppermann, Bad Vilbel (DE)

(73) Assignee: CONERGY AG, Hamburg (DE)

(21) Appl. No.: 12/161,679

(22) PCT Filed: Jan. 18, 2007
(86) PCT No.: PCT/EP07/00432

§ 371 Date: Oct. 13, 2009

(30) Foreign Application Priority Data
Jan. 19, 2006 (DE) 10 2006 002 698.5

(51) Int. Cl. H02M 3/335

(52) U.S. Cl. 363/21.12

(57) ABSTRACT

An inverter circuit for supplying solar power or wind power to a network or for network-independent operation. The inverter circuit includes a minimum number of components and can therefore be kept very compact.

The invention relates to an inverter circuit according to the preamble of claim 1 or 2.

There are various inverter techniques for feeding solar power into the network and for operation independently of the network. This is described briefly in the following:

For feeding into the network the input direct voltage is converted into alternating voltage impulses with variable pulse width, so that in a downstream connected filter a sinusoidal current is formed, which flows into the network. Owing to the lower weight and improved efficiency (95-97% instead of 92-94%) more and more inverters are being produced without a network transformer.

Inverters with r.f. transformers are also very light but their efficiency is only in the region of 92-94%. A particular feature of all inverters with r.f.-separation is that they are complex in design, have several r.f. stages and temporarily store the energy in the magnetic field of the transformer core, the electric field of storage capacitors and also again in filter stages.

Thus the objective of the invention is to create an inverter with galvanic separation, which only has one r.f. converter and temporarily stores the energy in the magnetic field of the r.f. fly-back transformer only once.

An inverter is used to achieve this objective which comprises the features of claim 1 or 2.

In this way it is achieved that the efficiency of the inverter according to the invention, as with the inverters without transformers, is at 95 to 97%, and due to the small number of components necessary for the functioning of the inverter the weight is much lower than in known inverters.

The invention is explained in more detail in the following with reference to a drawing.

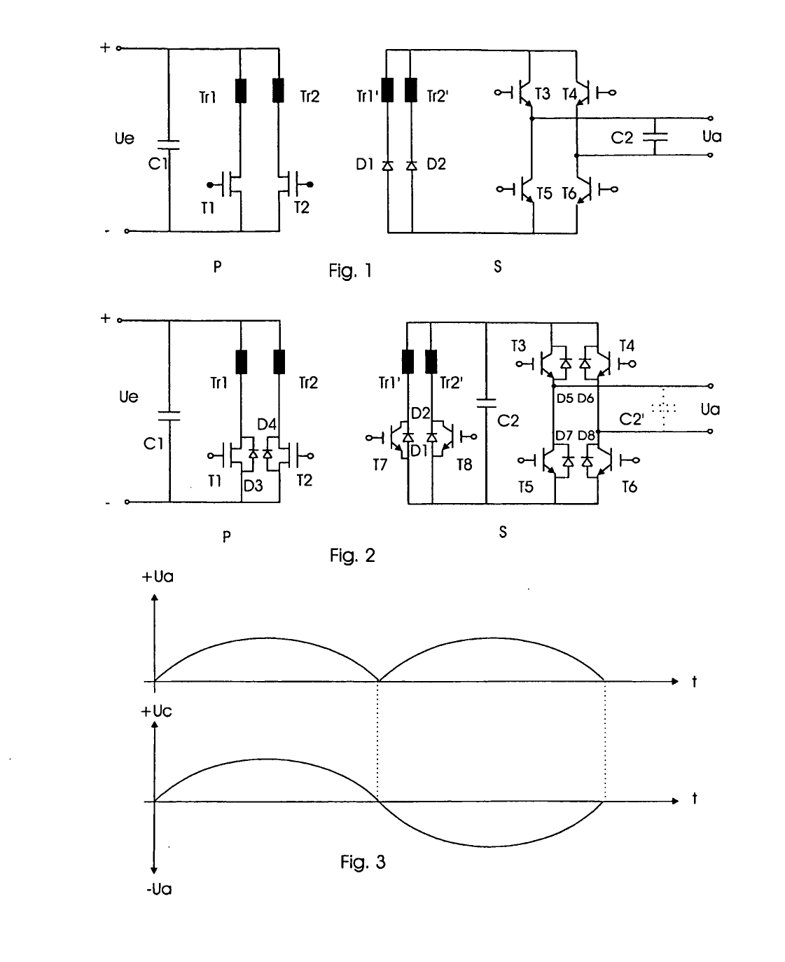

FIG. 1 shows an inverter circuit according to the invention for feeding current into the network;

FIG. 2 shows a modification of the inverter circuit according to the invention of FIG. 1 for operation independently of the network; and

FIG. 3 shows the voltage curve of the circuits according to FIGS. 1 and 2 at the output of the primary side and the secondary side.

It should be noted that in the figures the same parts are denoted by the same reference numbers.

FIG. 1 shows a first embodiment of the invention for feeding electricity into the network, whereby the electricity can be generated for example by the sun or by wind power.

At the input of the inverter is the input voltage Ue with its plus terminal connected to a first side of two parallel connected fly-back transformers Tr1 and Tr2, the other sides of which are connected via semiconductor switches T1 and T2 to the minus terminal. Between plus and minus there is also connected a capacitor C1, which assists with charging the fly-back transformers Tr1 and Tr2. The circuit also consists of a primary side P and a secondary side S.

On switching on T1 a current value is applied to the fly-back transformer Tr1 and thus magnetic energy is loaded onto the transformer core, which corresponds to 0.5*I²*L. In this case I is the supplied electricity and L the inductance of the respective fly-back transformer Tr1 or Tr2.

After switching off T1 the magnetic energy converts into electricity, which flows into the output capacitor C2 in the secondary side S via a diode D1 and an active network rectifier, consisting of a T3-T6. During the discharge phase of Tr1 the fly-back transformer Tr2 is charged and discharges via a diode D2 and the active network rectifier T3 to T6 into the output capacitor C2. Tr1 and Tr2 operate anticyclically and supply an almost continuous current into the output capacitor C2. The power received by the fly-back transformers is Pᵢₙ=0.5*I²*L*f. Here Pᵢₙ denotes the input power or the fly-back transformers Tr1 and Tr2, I denotes the current, L the inductance and f the frequency.

FIG. 2 shows an inverter circuit for operation independently of the network, in which in a modification of the circuit according to FIG. 1 in the primary side P the semiconductor switches T1 and T2 are bridged by diodes D3 and D4 and in the secondary side S the diodes D1 and D2 are bridged by semiconductors switches T7 and T8. Furthermore, the capacitor C2 in the secondary side S is not connected at the output, but between the fly-back transformers Tr1′, Tr2′ and the active network rectifier T3-T6. However, it should be noted that the capacitor C2 can also be connected at the output, as indicated in FIG. 2 by C2′ by dotted lines.

At the input of the inverter, on switching on T1 a current value is applied to the fly-back transformer Tr1 and thus magnetic energy is charged onto the transformer core, which corresponds to 0.5*I²*L. After switching off T1 the magnetic energy converts into electricity, which flows into the capacitor C2 and thereby transfers the energy 0.5*U²*C. The voltage curve at C2 can be controlled sinusoidally by the amount of energy portions supplied by the fly-back transformer. Depending on the load conditions at the capacitor C2 also the energy content charged to the fly-back transformer can be varied by varying the applied current.

The fly-back transformer Tr2 is controlled by T2 anticyclically in relation to the fly-back transformer Tr1 and transmits the current via D2 into the output capacitor C2. In order to obtain a sinusoidal curve of the voltage half-waves at C2 with rising and falling voltage under variable load conditions, the fly-back transformers Tr1 and Tr2 are operated forwards for rising voltage and backwards for falling voltage at the capacitor C2.

During the backwards operation for the primary-side fly-back transformer Tr1 on the primary side the diode D3 and on the secondary side the transistor T7 become active and for the primary-side fly-back transformer Tr2 the primary-side diode D4 and the secondary side transistor T8.

The following active network rectifier or polarity switch, which is formed by the semiconductors switches T3-T6 with bridging diodes D5-D8 for backwards operation, switches every second half-wave to negative voltage and thus produces the complete sinusoidal curve.

FIG. 3 shows the curve of the voltage Uc at the capacitor C2 in the circuit according to FIG. 2 as a function of time t. Two positive sinusoidal half waves are shown, the second of which is flipped over by the polarity switches T3-T6 to form a complete sinus wave downwards in the direction—Ua.

1. An inverter circuit for feeding solar power or wind power into a network operated at a voltage, wherein the inverter circuit includes a primary side and a secondary side, said inverter circuit comprising:
a fly-back transformer,
said fly-back transformer including two parallel windings both on the primary side as well as on the secondary side, with a positive input of input voltage being applied at one end of the primary side and a negative input terminal leading via a semiconductor switch to the respective other end of the primary-side windings of the fly-back, transformer;
a first capacitor between the positive and the negative input in front of the fly-back transformer to support the loading of energy into the primary-side windings of the fly-back transformer;
two diodes lying on the secondary side in series with the associated secondary winding of the fly-back transformer and thus parallel to one another,
each of said diodes being connected by the respective anode to an input terminal of an active power rectifier, and to the other input terminal of which the fly-back transformer is connected; and
a second capacitor connected across the output of the active power rectifier.

2. An inverter circuit for feeding solar power or wind power into a consumer unit and thereby for operation independently of a network, wherein the consumer unit is operated at a voltage, and wherein the inverter circuit includes a primary side and a secondary side, said inverter circuit comprising:
a fly-back transformer,
said fly-back transformer including two parallel windings both on the primary side as well as on the secondary side, with a positive input of input of the primary side and a negative input terminal leading via a semiconductor switch and a diode bridging the semiconductor switch to the respective other end of the primary-side windings of the fly-back transformer;
a first capacitor connected between the positive and the negative input terminal in front of the fly-back transformer to support the loading of energy into the primary-side windings of the fly-back, transformer;
two diodes lying on the secondary side in series with the associated secondary winding of the fly-back transformer and thus parallel to one another,
each of said diodes being connected by the respective anode to an input terminal of an active power rectifier, and to the other input terminal of which the fly-back transformer is connected;
two further semiconductor switches bridging the diodes; and
a second capacitor connected between the fly-back transformer and the active power rectifier.

3. The inverter circuit as claimed in claim 2; and
a plurality of diodes bridging the transistors of the power rectifier for reverse operation.
